(19) United States
(12) Patent Application Publication
(10) Pub. No.: US 2024/0057816 A1
(43) Pub. Date: Feb. 22, 2024

(54) Grill Cleaning Tool

(71) Applicant: Bruno Fernandez, Port Neches, TX (US)

(72) Inventor: Bruno Fernandez, Port Neches, TX (US)

(21) Appl. No.: 17/891,821

(22) Filed: Aug. 19, 2022

(51) Int. Cl. A47J 37/07

(52) U.S. Cl. CPC A47J 37/0786

(57) ABSTRACT

A grill cleaning tool having an elongated shaft with a handle at a first end and a second opposing end in the form of a hoop in a plane. A shaped protrusion is disposed proximate the second end of the elongated shaft, with a distal end of the shaped protrusion pointing toward the hoop.

### FIELD OF THE INVENTION

This disclosure relates generally to devices for securing objects for manual use in applications that can cause injury to a user and, in particular, to a tool configured to facilitate cleaning of hot grates such as barbecue grill surfaces.

### BACKGROUND

Cooking food on grills is a common activity, both indoor and outdoor. Grills come in a variety of forms, including those fueled by charcoal, wood pellets, or gas. The fuel source produces the heat for cooking and the food is placed on a grate or other support structure above the heat. The process of cooking on grills results in the accumulation of grease, food particles, and other charred debris on the grate surface of the grill. This charred debris is formed from the foods cooked on the grate surface. The presence of this debris can negatively affect the taste and appearance of food being cooked. It can also pose a fire hazard. Thus, it is desirable to clean the grill in order to remove the charred debris, grease, and other undesirable substances from the grate surface. A number of conventional tools are used for cleaning the grate surface of grills, including wire brushes and scraper tools.

These tools have their drawbacks. Brushes become clogged with debris and cannot be effectively cleaned. Metal brushes pose a safety risk to users due to the possibility of wire bristles being left on the grate surface which can attach to food that is cooked on the grill. The ingestion of such bristles or brush fragments is potentially very dangerous, causing harm to a person's stomach and digestive tract. Scrapers generally only clean the top surface of the grill grate, leaving debris remaining on the sides and bottoms of the grate.

Thus, there remains a need for an improved grill cleaning tool that is safe to use and effective for removing debris from a grill surface.

### SUMMARY

According to an aspect of the invention, a grill cleaning tool includes an elongated shaft having a first end with a handle; the elongated shaft having a second end in the form of a hoop in a plane; and a shaped protrusion disposed proximate the second end of the elongated shaft, wherein a distal end of the shaped protrusion points toward the hoop.

According to another aspect of the invention, a grill cleaning tool includes an elongated shaft having a first end with a handle and an opposing second end having the form of a hoop in a plane; and at least one shaped protrusion extending from a surface of the elongated shaft, wherein the at least one shaped protrusion has the form of a hook with a distal end pointing toward the hoop.

According to another aspect of the invention a grill cleaning tool includes an elongated shaft having a first end with a handle and an opposing second end having the form of a hoop in a plane; and at least one shaped protrusion extending from a surface of the hoop, wherein the at least one shaped protrusion has the form of a hook with a distal end pointing toward the hoop.

Other aspects of the embodiments described herein will become apparent from the following description and the accompanying drawings, illustrating the principles of the embodiments by way of example only.

### BRIEF DESCRIPTION OF THE DRAWINGS

The following figures form part of the present specification and are included to further demonstrate certain aspects of the present disclosure and should not be used to limit or define the claimed subject matter. The claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1 shows an overhead view of a grill cleaning tool according to an example of the present disclosure.

FIG. 2 shows a side view of another grill cleaning tool according to an example of the present disclosure.

FIG. 3 shows a blown-up perspective view of another grill cleaning tool according to an example of the present disclosure.

FIG. 4 shows an overhead view of another grill cleaning tool according to an example of the present disclosure.

FIG. 5 shows a schematic of a grill cleaning tool as used with a cooking grill according to an example of the present disclosure.

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness.

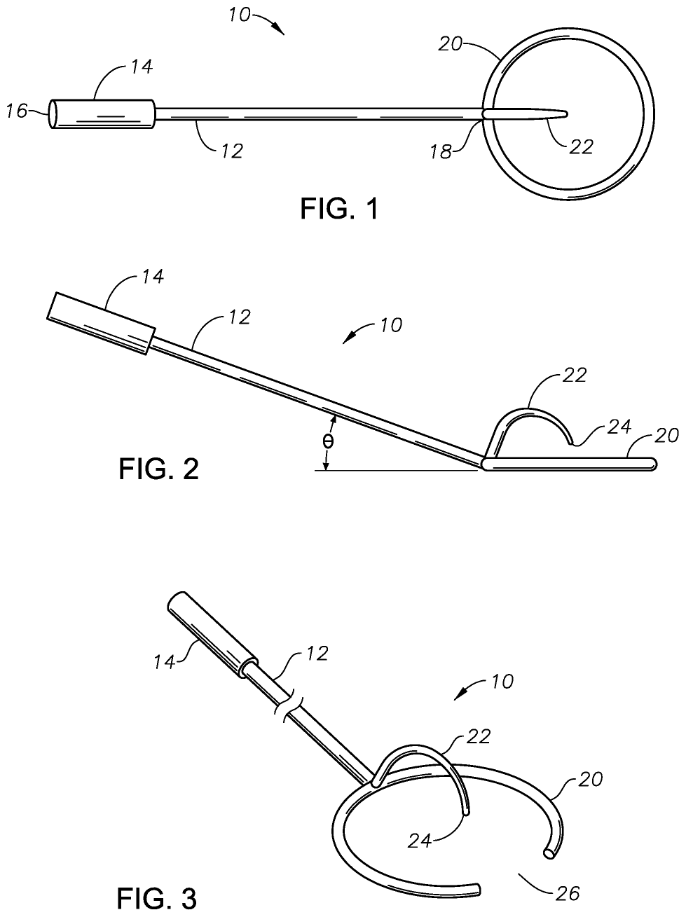

FIG. 1 shows an overhead view of a grill cleaning tool 10 embodiment of this disclosure. An elongated shaft 12 having a longitudinal axis has a handle 14 at a first end 16. The opposing second end 18 of the shaft is configured in the form of a hoop 20. As used herein the term “hoop” will be understood to define a generally curving line in a plane forming a closed or partially open curve (for example, but not limited to, a circle, oval, etc.). A shaped protrusion 22 is disposed proximate the second end 18 of the elongates shaft 12, extending over the hoop 20. It will be appreciated by those skilled in the art that any suitable materials may be used for implementations of the disclosed grill cleaning tool 10 embodiments. For example, the handle 14 may be formed of wood, plastics, or suitable composites. The elongated shaft 12 may also be formed of conventional materials (e.g., metal, composites, etc.) providing sufficient strength to sustain the pressure/stress applied by a user and exposure to the heat produced by conventional food cooking grills.

Embodiments of this disclosure may be implemented with the elongated shaft 12, the hoop 20, and the shaped protrusion 22 formed as a unitary component via conventional manufacturing processes (e.g., die casting, waterjet cutting, etc.). Other embodiments may be implemented with the elongated shaft 12, the handle 14, the hoop 20, and/or the shaped protrusion 22 formed as individual components joined together to form the tool 10 (e.g., via welding). Some embodiments may also be implemented with the handle 14 formed on the elongated shaft 12 (e.g., knurled handle).

FIG. 2 shows a side view of another grill cleaning tool 10 embodiment of this disclosure. In this embodiment, the elongated shaft 12 is at an angle θ with respect to the plane of the hoop 20. The angle θ can be any desired angle. In this embodiment, the shaped protrusion 22 stems from the junction where the elongated shaft 12 terminates at the second end 18 to couple to the hoop 20. As shown in FIG. 2, embodiments can be implemented with the shaped protrusion 22 shaped such that a distal end 24 of the protrusion points back toward the hoop 20 without passing through the plane of the hoop. Some embodiments can be implemented with the shaped protrusion 22 stemming outward along a plane perpendicular to the plane of the hoop 20.

FIG. 3 shows a blown-up view of the hoop 20 end 18 of another tool 10 embodiment of this disclosure. In this embodiments, the hoop 20 forms a semi-circle in a plane, with an opening 26 formed along the hoop. As shown in FIG. 3, embodiments can be implemented with the shaped protrusion 22 having the form of a curved hook with a pointed distal end 24 pointing back toward the hoop 20, preferably aimed at the center of the hoop.

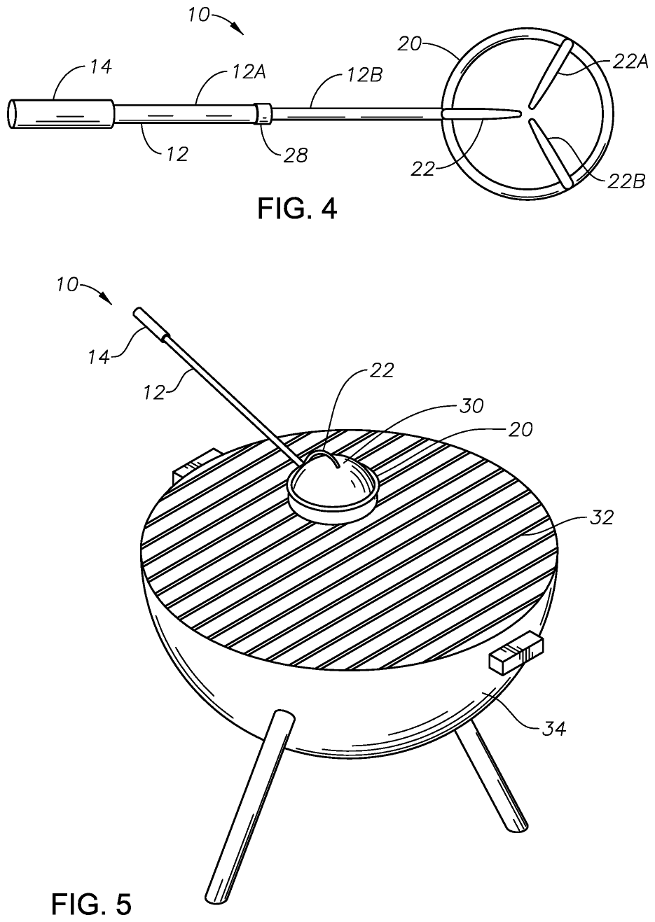

FIG. 4 shows an overhead view of another grill cleaning tool 10 embodiment of this disclosure. In this embodiment, the elongated shaft 12 consists of telescoping tube sections 12A, 12B with a locking ring 28 that permits a user to selectively adjust the length of the elongated shaft. The embodiment of FIG. 4 is also configured with multiple shaped protrusions 22, 22A, 22B. One shaped protrusion 22 stems from the elongated shaft 12 and the other protrusions 22A, 22B from the surface of the hoop 20, with the distal end 24 of each protrusion pointing toward the hoop.

Grilling enthusiasts have discovered the benefits of using onions to clean soiled grills. In addition to being a safer alternative to chemical cleaners, an onion's natural acidity and fluids have proven to effectively loosen dirt, stuck-on food, and grease from grill grates. In conventional use of onions to clean cooking grills, an onion is typically cut in half and gripped with tongs or sometimes held by hand and directly rubbed against the grill grate surface to clean the debris. These methods of holding an onion for such purposes are not very effective and can lead to burn injuries.

The grill cleaning tool 10 embodiments of this disclosure provide advantages over conventional techniques. FIG. 5 shows a tool 10 embodiment of this disclosure. An object 30 is disposed in the hoop 20, and the shaped protrusion 22 is embedded within the object to retain it on the hoop. The object 30 can be any desired item a user wishes to apply onto the grate 32 of the grill 34 (e.g., soap ball, sponge, steel wool pad, onion, etc.). When the object 30 consists of an onion cut in half, the tool 10 allows a user to effectively run the onion across the hot grate 32 surface while maintaining a safe distance from the grill 34. In this manner, the tool 10 provides a practical and efficient means for a user to clean the hot grate 32. Once the grate 32 has been cleaned, a user can easily dislodge the object 30 (e.g., the onion half) from the extended protrusion 22 and the hoop 20.

In light of the example embodiments described and illustrated herein, it will be recognized that numerous modifications could be applied to derive alternative embodiments of the present invention. It will also be appreciated by those skilled in the art that embodiments may be implemented using conventional materials (e.g., metals, composite materials, heat resistant plastics, etc.) and components. What is claimed as the invention, therefore, are all implementations that come within the scope of the following claims.

What is claimed is:

1. A grill cleaning tool comprising:
an elongated shaft having a first end with a handle;
the elongated shaft having a second end in the form of a hoop in a plane; and
a shaped protrusion disposed proximate the second end of the elongated shaft,
wherein a distal end of the shaped protrusion points toward the hoop.

2. The grill tool of claim 1 wherein the shaped protrusion extends from a surface of the hoop.

3. The grill tool of claim 1 wherein the shaped protrusion extends from a surface of the elongated shaft

4. The grill tool of claim 1 wherein the plane of the hoop is at an angle with respect to a longitudinal axis of the elongated shaft.

5. The grill tool of claim 1 wherein the shaped protrusion is configured to form a hook.

6. The grill tool of claim 1 wherein the hoop consists of a closed circular form.

7. The grill tool of claim 1 wherein the shaped protrusion is disposed proximate the second end of the elongated shaft along a plane perpendicular to the plane of the hoop.

8. The grill tool of claim 1 wherein the hoop is configured to receive an object.

9. The grill tool of claim 8 wherein the shaped protrusion is configured to retain the object on the hoop.

10. The grill tool of claim 1 further comprising a plurality of shaped protrusions disposed proximate the second end of the elongated shaft.

11. The grill tool of claim 10 wherein a distal end of each of the shaped protrusions points toward the hoop.

12. The grill tool of claim 1 wherein the elongated shaft is configured for selective length adjustment.

13. A grill cleaning tool comprising:
an elongated shaft having a first end with a handle and an opposing second end having the form of a hoop in a plane; and
at least one shaped protrusion extending from a surface of the elongated shaft,
wherein the at least one shaped protrusion has the form of a hook with a distal end pointing toward the hoop.

14. The grill tool of claim 13 wherein the plane of the hoop is at an angle with respect to a longitudinal axis of the elongated shaft.

15. The grill tool of claim 13 wherein the hoop consists of a closed circular form configured to receive an object, and the at least one shaped protrusion is configured to retain the object on the hoop.

16. The grill tool of claim 13 wherein the elongated shaft is configured for selective length adjustment.

17. A grill cleaning tool comprising:
an elongated shaft having a first end with a handle and an opposing second end having the form of a hoop in a plane; and
at least one shaped protrusion extending from a surface of the hoop,
wherein the at least one shaped protrusion has the form of a hook with a distal end pointing toward the hoop.

18. The grill tool of claim 17 wherein the plane of the hoop is at an angle with respect to a longitudinal axis of the elongated shaft.

19. The grill tool of claim 17 wherein the hoop consists of a closed circle configured to receive an object, and the at least one shaped protrusion is configured to retain the object on the hoop.

20. The grill tool of claim 17 wherein the elongated shaft is configured for selective length adjustment.
